(19) United States
(12) Patent Application Publication
(10) Pub. No.: US 2003/0070324 A1
(43) Pub. Date: Apr. 17, 2003

(54) System and method for producing an electronic display on moving footwear

(76) Inventor: Webb T. Nelson, Woodinville, WA (US)

Correspondence Address: Eric A. LaMorte, P.O. Box 434, Yardley, PA, 19067-8434, US

(21) Appl. No.: 09/978,288

(22) Filed: Oct. 17, 2001

(51) Int. Cl. F21V 21/08; A43B 23/00

(52) U.S. Cl. 36/137; 362/103

(57) ABSTRACT

A system and method for producing an electronic image or message in moving footwear by the synchronous flashing of lights in an array. A shoe is provided having at least one array or lights visible on the exterior of the shoe. Within the shoe is circuitry that monitors when the shoe is in motion. By monitoring the change in pace in the stride of a person wearing the shoe, subsequent strides can be predicted. The lighting of the lights in the arrays is synchronized to the predicted strides just prior to that stride. As such, the lighting of the light arrays is synchronized to a stride when it occurs. By synchronizing the light arrays to a person's stride, images can be created on the footwear that would be comprehendible to any person watching the footwear on a moving person.

### BACKGROUND OF THE INVENTION

1. Field of the Invention

The present invention relates to assemblies that contain an array of light emitting diodes (LEDs) that produce a pattern or display while moving. The present invention also relates to footwear and the adoption of lights into the structure of footwear.

2. PRIOR ART STATEMENT

The prior art record is replete with different types of footwear that contain electronic components. Footwear has been manufactured with light emitting diodes (LEDs) that light whenever the footwear contacts the ground. However, the LEDs in such footwear are used for illumination purposes only, thereby adding only to the aesthetics of the footwear.

The prior art is also replete with display devices that use an array of LEDs to produce a predetermined pattern or alphanumeric message as the device moves. In such prior art devices, an array of LEDs is placed onto a moving surface. The LEDs are selectively lit. However, to create a comprehendible image or message, the lighting of the LEDs must be synchronized to the velocity of the moving surface. As such, by selectively synchronizing the lighting of different combinations of LEDs to the velocity of the moving object, clearly readable alphanumeric messages can be produced on the moving surface.

Since the lighting of the LEDs must be synchronized to the velocity of the moving surface on which the LEDs are placed, such systems are typically limited to spinning or waving objects where the velocity of the object does not fluctuate wildly. For example, in U.S. Pat. No. 5,406,300 to Tokimoto, entitled Swing Type Aerial Display System, an array of LEDs is placed on a waving wand. In U.S. Pat. No., 6,______ to Nelson, entitled Toy Top With Message Display And Associated Method Of Initiating And Synchronizing The Display, an array of LEDs is placed on a spinning top.

The present invention applies an array of LEDs to footwear in a manner that causes the LEDs to produce an image or an alphanumeric message as the footwear moves. The present invention solves the problems associated with synchronizing the lighting of the LEDs with the often erratic movement of a person's foot in order to create a sharp image of an alphanumeric message. The device and method of operation for the present invention are described and claimed below.

### SUMMARY OF THE INVENTION

The present invention is a system and method of producing an electronic image or message in moving footwear by the synchronous flashing of lights in an array. A shoe is provided having at least one array or lights visible on the exterior of the shoe. Within the shoe is circuitry that monitors when the shoe is in motion. By monitoring the change in pace in the stride of a person wearing the shoe, subsequent strides can be predicted. The lighting of the lights in the arrays is synchronized to the predicted strides just prior to that stride. As such, the lighting of the light arrays is synchronized to a stride when it occurs.

By synchronizing the light arrays to a person's stride, images can be created on the footwear that would be comprehendible to any person watching the footwear on a moving person.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a side view of a shoe in accordance with the present invention;

FIG. 2 is a front view of a person running with the shoes of FIG. 1, thereby creating a comprehendible message;

FIG. 3 is a schematic diagram indicating the electronic components of the present invention;

FIG. 4 is a graph plotting change in acceleration against time and showing a corresponding digital pulse;

FIG. 5 is a logic flow illustrating the method of operation of the invention.

### DETAILED DESCRIPTION OF THE INVENTION

Although the present invention system can be applied to any type of footwear, such as sandals or dress shoes, the present invention system is especially useful when applied to athletic shoes, such as sneakers. As such, by way of example, the present invention system and method will be described in an application where it is applied to a pair of running sneakers, in order to present the best mode contemplated for the invention.

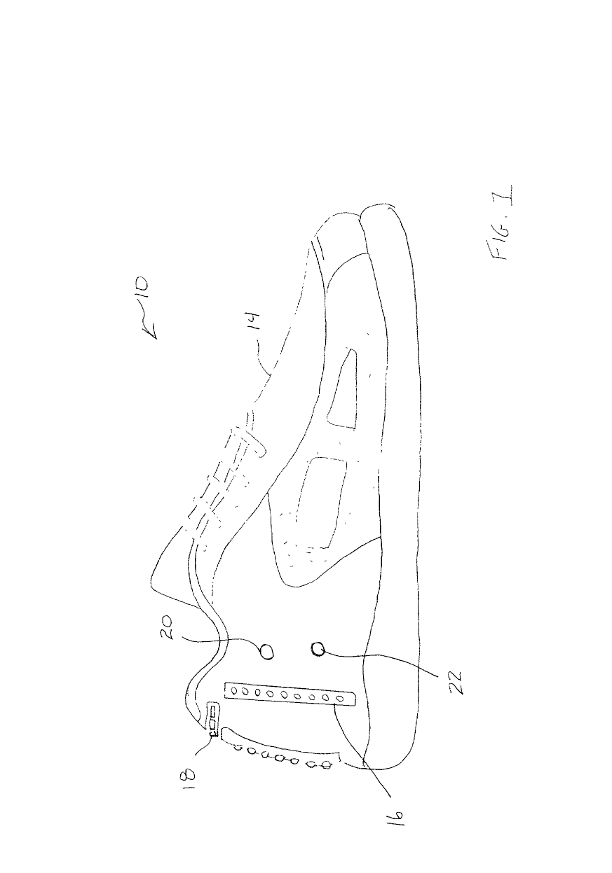

Referring to FIG. 1, a running sneaker 10 is shown. The running sneaker 10 has a sole 12 and a shoe upper 14. On the shoe upper 14 of the running sneaker 10 is located at least one array 16 of light emitting diodes (LEDs). In the shown embodiment, an array 16 of LEDs is shown on the right side of the sneaker 10. However, it will be understood that other arrays can be present on the unshown left side of the sneaker 10 and rear of the sneaker 10.

A programming interface 18, comprising input buttons may also be contained on the sneaker 10. The buttons of the programming interface 18 enable a user to program different alphanumeric characters into the electronics of the sneaker 10, as will later be explained. Alternatively, the buttons of the programming interface 18 can also be used to select a preprogrammed pattern from a library of patterns contained within the electronics of the sneaker 10. In the simplest version of the system, no programming interface 18 would be present. Rather, the arrays 16 of LEDs would be preprogrammed with one or more repeating patterns or messages. These same patterns and/or messages will repeat whenever the arrays 16 of LEDs are activated.

An optional on/off switch 20 and light sensor 22 are also shown in the embodiment of FIG. 1. The on/off switch 20 enables a user to selectively activate and deactivate the array 16 of LEDs. The optional light sensor 22 detects ambient light and activates the array 16 of LEDs only when ambient light falls below a threshold that enables the LEDs to be readily seen.

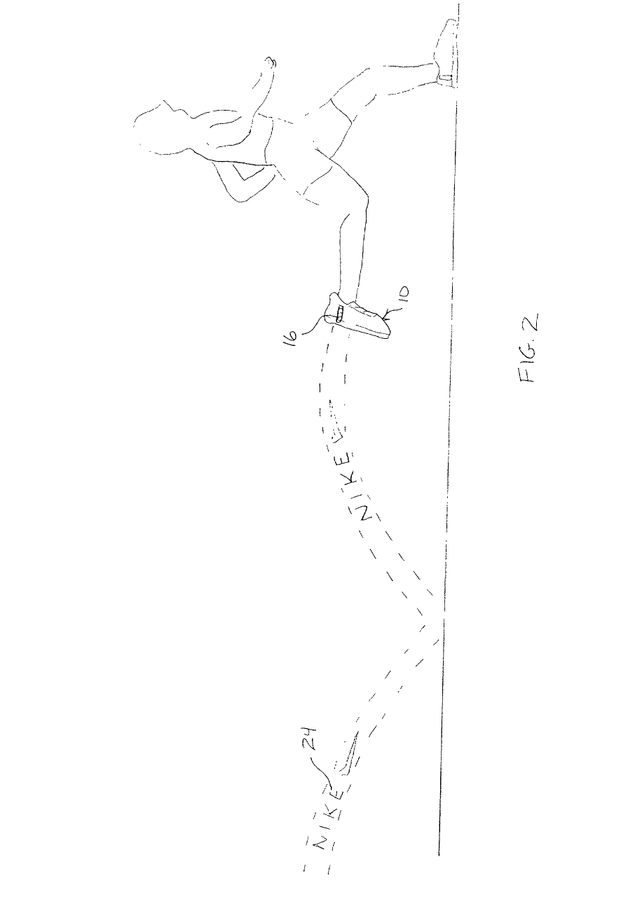

Referring to FIG. 2, it can be seen that as a person runs, jogs or walks with the sneakers 10 on, the array 16 of LEDs on the sneaker 10 moves through a repeating arcuate path. However, the frequency “f” associated with that movement varies rapidly as a person changes velocity, changes steps or shuffles their feet. The present invention system synchronizes the array 16 of LEDs so that the lighting of the LEDs in the array 16 is coordinated to the movement being experienced by the LEDs. As a result, the array 16 of LEDs produces a visually comprehendible image and/or an alphanumeric message 24. In the shown embodiment, the corporate trademark symbol and name “NIKE” of the Nike Company of Portland, Oreg. are shown as examples.

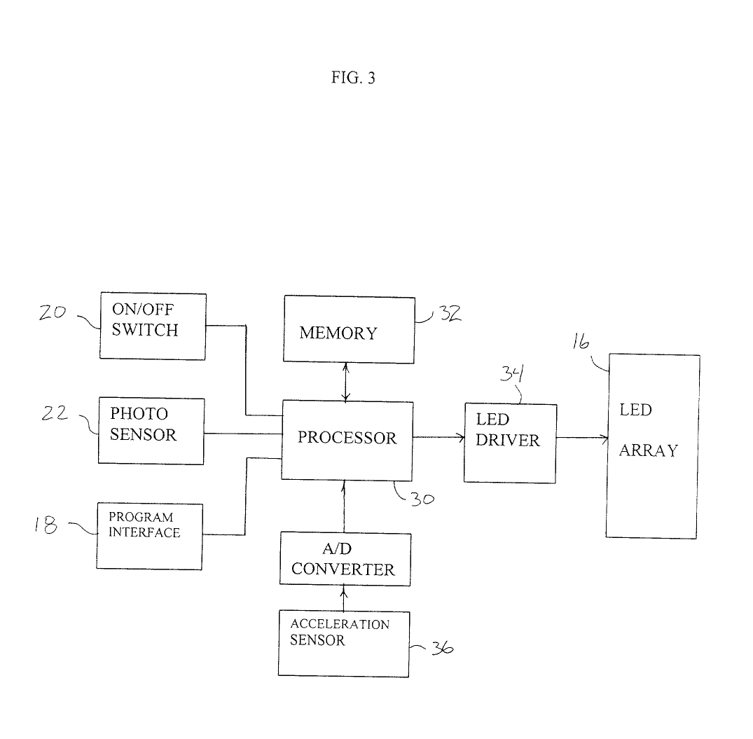

Referring to FIG. 3, a block diagram schematic of the present invention system is shown. As is indicated, the system contains a processor 30 and a memory 32. The memory 32 is used to store images and/or alphanumeric messages. If the system has only preprogrammed images and/or alphanumeric messages, the memory 32 can be a read only memory (ROM). However, if different images and or alphanumeric messages can be selectively added to the memory 32 through the programming interface 18, then a random access memory (RAM) is used.

The processor 30 is coupled to an LED driver 34 that lights the LEDs in the various arrays 16. The processor 30 lights the LEDs in the pattern selected from, or stored within, the memory. The processor 30 therefore knows what pattern to light the LEDs, however, the timing of when to light the various LEDs is still an unknown variable. The timing of when to light the LEDs has to be synchronized with the velocity at which the LEDs are moving. If not synchronized, the image or alpha-numeric message produced will not be comprehendible and will appear to be nothing more than flashing lights. To synchronize the lighting of the LEDs, an acceleration sensor 36 is used. The acceleration sensor 36 can be an electronic accelerometer, or any type of mechanical tilt switch that activates only when a predetermined change in acceleration is experienced.

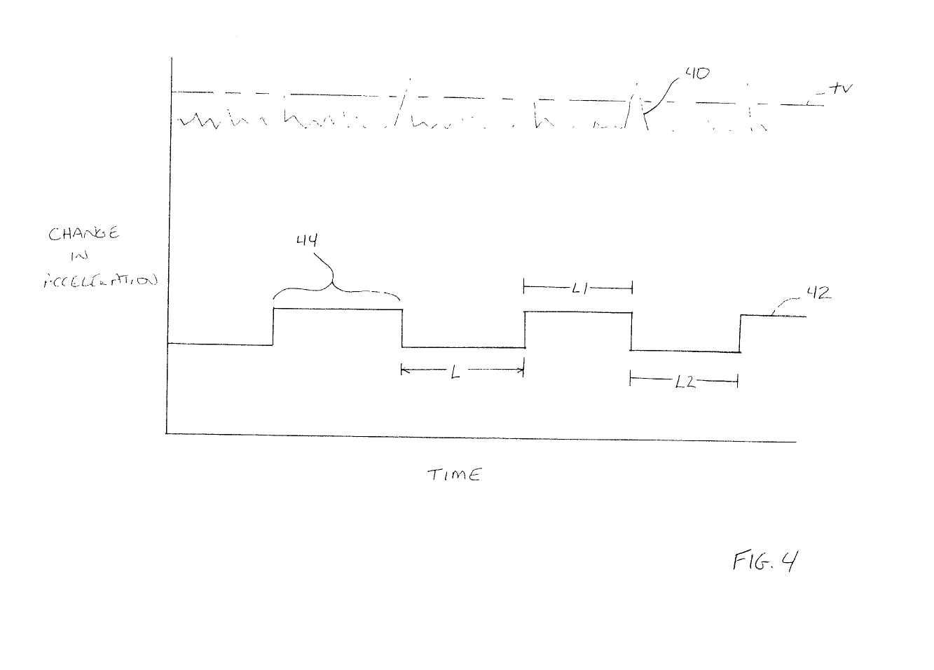

In FIG. 2, a running person is shown. As a person's sneaker strikes the ground, a large change in acceleration is experienced by that sneaker. This sudden change in acceleration is sensed by the acceleration sensor 36 (FIG. 3) in the sneaker. Referring now to FIG. 4, it can be seen that at each moment of contact with the ground, a large change in acceleration is experienced. The acceleration sensor 36 (FIG. 3) detects these changes in acceleration. The acceleration sensor 36 (FIG. 3) creates an analog signal 40, wherein the analog signal 40 is indicative of changes in acceleration experienced by the sneaker. The analog signal 40 from the acceleration sensor 36 (FIG. 3) is converted into a corresponding digital signal 42. The digital signal 42 is shown on the same graph as the analog signal 40. Each time the acceleration sensor 36 (FIG. 3) experiences a large change in acceleration and produces an analog signal 40 that surpasses a predetermined threshold value (tv), the digital signal changes state between a “1” and “0” Consequently, as a person runs, the impact of that person's sneakers with the ground creates a pulsed digital signal. The length of each “1” or “0” pulse wave 44 corresponds in time to the period of time between when a particular sneaker strikes the ground. Accordingly, by monitoring the length of each pulse wave 44, the stride of the person can be determined.

If a person is not moving or is walking slowly, the changes in acceleration that are sensed will not surpass the threshold value (tv), and will not cause a change in the digital pulse wave 44. However, a purposeful walk, jog or run will cause sufficient impact with the ground to create a changing digital pulse wave 44.

From FIG. 4, it can be seen that each pulse wave 44 has a length (L). The length (L) of each pulse wave 44 directly corresponds to the duration of a person's stride. If a first pulse wave has a length L1 and the next pulse wave has a longer or shorter pulse wave L2, then it can be determined that a person's stride is changing. Using this change, an estimate can be calculated for the next stride using the below stated formula.

$${L}_{e s t} = \frac{{L}_{N}}{{L}_{N - 1}} \times {L}_{N} \qquad ( equation 1 )$$

Where, Lₑₛₜ is the estimated length of the next pulse wave, L_{N} is the length of the last pulse wave and L_{N-1} is the length of the second to last pulse wave. For example, if a person were jogging at a steady pace of one step per ½ second, using equation 1, it would be estimated that the next step would also have a ½ second duration. However, if a person were slowing down from a fast run to a near stop, as is common in the game of basketball, equation 1 can be used to calculate the upcoming pace of steps during periods of deceleration and acceleration.

Using equation 1, the pace of the next step of a person can be anticipated with some degree of accuracy. Using this anticipated pace, the lighting of the LEDs in the arrays can be synchronized to this anticipated pace. As such, if the anticipated pace is accurate between 65% and 90% of the time, the synchronization of the LEDs in the arrays will also be accurate between 65% and 90% of the time. Consequently, the image or alphanumeric message 24 (FIG. 2) created by the LEDs in the arrays will be synchronized to the movement and comprehendible for these same periods of time.

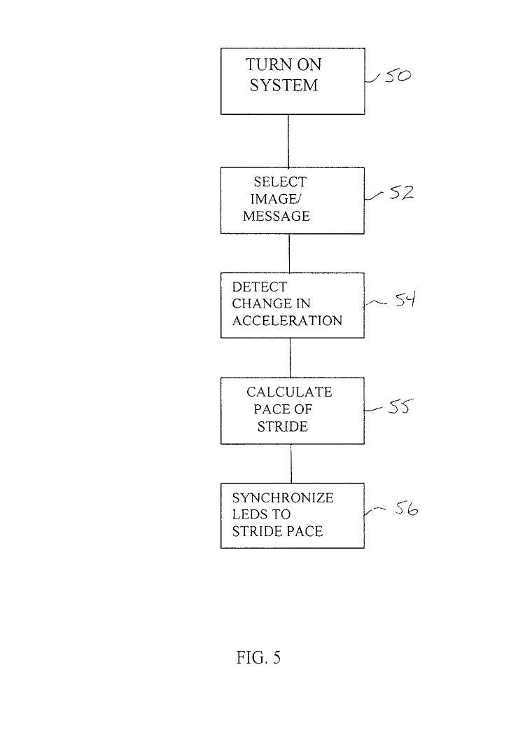

Referring to FIG. 5, the method of operation for the present invention system is described. As is indicated by Block 50, a person first turns on the electronics contained within a pair of sneakers. This is done by moving the on/off switch 20 (FIG. 3) on the exterior of each sneaker. However, if the system comes with a light sensor 22 (FIG. 3) the system may not activate until ambient light levels fall below some predetermined minimum threshold.

Once activated, a person can then select or create an image or alphanumeric message. See Block 52. This is done using the programming interface 18 (FIG. 3) on the sneaker. After the image or message is selected, the sneaker can be placed on the foot and worn. Of course, the sneaker can be activated and message selected after the sneaker is being worn. However, ergonomics suggest that it would be easier to program the display of the sneaker when it can be held comfortably in the user's hands.

If the sneaker contains a repeating preprogrammed image or message, the step of actively selecting an image or alphanumeric message can be skipped.

As the sneakers are worn, each sneaker acts independently of the other. Each sneaker detects changes in acceleration that surpass a certain threshold, as is indicated by Block 54. As has been previously described, the pace of the occurrences of large acceleration changes corresponds to the pace of the user's movement. From Block 54, it can be seen that by using equation 1, the pace of movement for the different sneakers can be calculated using the change in pace from the two previously detected strides of movement for that sneaker. The calculated pace is used to synchronize the LEDs in the various arrays, as is indicated by Block 56. The LEDs in the arrays are synchronized to the anticipated stride before that stride occurs. This is done prior to each step. Accordingly, if the pace of a stride does correspond to the anticipated stride, the LEDs are perfectly synchronized to that movement.

As such, the present invention system uses previous strides to determine a rate of change. The calculated rate of change is then used to predict the next stride before that stride occurs. The lighting of the LEDs in the various arrays is then synchronized to the predicted stride. If the predicted stride does occur, the LEDs are perfectly synchronized and the LEDs produce a clear image or message.

It will be understood that the system and method of the present invention described and illustrated are merely exemplary and a person skilled in the art can make many variations to the shown embodiment. For example, the illustrated sneaker can be of any model and style. The arrangement of LEDs in an array can also be arranged in different patterns to better integrate with the style of the shoe. All such alternate embodiments and modifications are intended to be included within the scope of the present invention as defined below in the claims.

What is claimed is:

1. A shoe assembly, comprising:
a shoe having a soles and an upper section, wherein said shoe is sized to contain a person's foot therein;
at least one array of lights visible on the exterior of said upper section of said shoe;
circuitry supported by said shoe that selectively lights said at least one array of lights to create a message, wherein said circuitry selectively lights said array of lights in timed synchronization to the stride pace of a moving person wearing said shoe.

2. The assembly according to claim 1, wherein said message is selected from an image and a string of alphanumeric characters.

3. The assembly according to claim 1, wherein said circuitry includes a sensor that detects when said shoe contacts the ground while being worn.

4. The assembly according to claim 3, wherein said sensor generates a contact signal each time said shoe contacts the ground with a force over a predetermined threshold.

5. The assembly according to claim 4, wherein said circuitry further includes a processor for monitoring the length of time between each contact signal.

6. The assembly according to claim 5, wherein said processor synchronizes the lighting of said at least one array of lights as a function of said length of time between each contact signal.

7. The assembly according to claim 5, wherein said processor synchronizes the lighting of said at least one array of lights as a function of a difference between the lengths of time of two previous contact signals.

8. The assembly according to claim 2, further including a user interface for selectively selecting said message.

9. The assembly according to claim 2, wherein said circuitry further includes a memory for storing said message.

10. A method of creating a message display on a moving shoe, comprising the steps of:
providing a shoe having an array of lights thereon;
selecting a message to be displayed by said array of lights; and
synchronizing the lighting of said array of lights as a function of the stride of a person wearing the shoe.

11. The method according to claim 10, wherein said step of selecting a message includes selecting a preprogrammed message from a library of messages stored in a memory.

12. The method according to claim 10, wherein said step of selecting a message includes selectively entering a message through a user interface.

13. The method according to claim 10, wherein said step of synchronizing the lighting of the lights includes:
creating a signal each time said shoe contacts the ground with at least a predetermined force;
monitoring time intervals between each said signal;
synchronizing the lighting of said array as a function of said time intervals.

14. The method according to claim 13, wherein the sub step of synchronizing the lighting of said array as a function of said time intervals further includes calculating a future time interval from previous time intervals and synchronizing the lighting of said array to said future time interval.

15. The method according to claim 10, wherein said step of selecting a message includes selecting a message from a selection of preprogrammed messages held in a memory.

16. The method according to claim 10, wherein said step of selecting a message includes selectively inputting a message into an interface that is supported by the shoe.
